(19) United States
(12) Patent Application Publication
(10) Pub. No.: US 2020/0139546 A1
(43) Pub. Date: May 7, 2020

(54) ROBOTIC SAW AND WATER JET CONTROL

(71) Applicant: Park Industries, Inc., St. Cloud, MN (US)

(72) Inventors: Russel Kerfeld, Sartell, MN (US); Robert Penas, Silver Lake, MN (US); Christopher R. Lampert, Bowlus, MN (US)

(21) Appl. No.: 16/179,248

(22) Filed: Nov. 2, 2018

(51) Int. Cl. B25J 9/16; B26F 3/00; B25J 11/00; B25J 13/08

(52) U.S. Cl. CPC B25J 9/1666; B26F 3/004; B25J 19/02; B25J 13/089; B25J 11/0055

(57) ABSTRACT

Disclosed herein are systems and methods for controlling an industrial robot. The system can include an industrial robot having a plurality of axes and a saw and water jet end effector. The system can also include an off-line program for controlling the industrial robot. The off-line program can include creating a tool path based on a prescribed cut pattern, then analyzing the tool path for kinematic singularity occurrences. If a kinematic singularity is found, it is avoided by creating corrected sub-paths. The corrected sub-path is then reanalyzed for kinematic singularity occurrences and corrected if needed. The tool path is then analyzed for collisions that occur between cutting motion segments, and avoiding those collisions by creating new paths of travel between cutting motion segments. Once the corrected sub-path is complete, the system includes translating and sending the corrected sub-path to the industrial robot.

### TECHNICAL FIELD

The present invention relates to devices, systems, and methods for controlling an industrial robot, and more particularly, controlling an industrial robot with saw and water jet end effector.

### BACKGROUND OF THE INVENTION

Industrial robots are conventionally used in many industries to increase manufacturing quality and output. Among the various industries that utilize industrial robots, the granite and related marble industries are using industrial robots at an increasing rate to accommodate more intricate cutting patterns. One use of industrial robots within the granite and related marble industries is for accurately cutting slabs of material for use in residential and commercial table tops and countertops.

Conventionally, industrial robots used for cutting slabs of material use an end effector that is a combination rock-cutting saw blade and water jet cutting head. In such a configuration, the saw blade is used to cut straight sections of stone material at a high rate of speed and the water jet is used to cut curves and corners, but at a slower rate of speed. Generally, a cut pattern is imported from a computer aided drafting program and converted into a set of cutting instructions. Often, the initial set of cutting instructions includes errors, such as a collision occurring within the tool path. In order to alleviate this issue, tool paths are run through off-line programming and simulation.

Off-line programming and simulation is used to create robotic instructions in a virtual robotic cell and, once complete, those instructions are then uploaded to a real industrial robotic cell. Conversely, on-line robotic programming is created at the robot cell with a teaching pendant to teach the robot a particular set of repeatable instructions. Because of the inherent inefficiencies and limitations of on-line robotic programming, off-line robotic programming and simulation is preferred within the industry to be used in place of or in combination with on-line programming. A combination of the two programming techniques can be used such that off-line programming and simulation is followed by on-line programming for further refining and verification.

In the granite and related marble cutting industries, which use a saw and water jet end effector, solutions to tool-path problems are limited beyond what conventional off-line programming and simulations can solve for. For example, one limitation on the solutions to tool-path problems is that a corrected sub-path (i.e. a tool path that does not encounter the indicated problem) must be similar enough to the problematic tool path so as to create the same cut in the material. The solution cannot simply be a different path of travel between two points in space. And more particularly with respect to saw and water jet end effectors, the cutting orientation of the saw blade and water jet with respect to the work piece must be maintained through any solution in order to properly cut the material.

In the industry, problems within a tool path cause degradation in cutting performance and efficiency. Problems within a tool path are especially difficult to overcome considering alternative path limitations of industrial robots having saw and water jet end effectors.

### SUMMARY

Embodiments disclosed herein are directed to devices, systems and methods of cutting a slab of material with an industrial robot. In particular, embodiments disclosed herein are directed to cutting a slab of material with an industrial robot tool path that avoids tool path problems, such as kinematic singularities and collisions. In particular, kinematic singularities are motion stop events that occur when an industrial robot moves in such a way that two or more of its axes of rotation align, rendering associated joint locations indeterminant. Collisions can occur when the tool path of the industrial robot intersects a physical structure, such as the cutting table, work piece or other structure.

In particular, embodiments disclosed herein include off-line programming and simulation to avoid singularities by detecting them, then changing the instructions for the robot such that the end effector reaches the same point coordinate in a difference way, i.e., a way that does not configure the robot in a kinematic singularity position. The present invention provides an off-line programming of the robot which includes assessing a tool path for kinematic singularities, and if found, adjusting the degree of tilt of the saw blade iteratively until no singularities occur within the tool path.

In one embodiment, a system for cutting a slab of material is disclosed. The system includes an industrial robot having a plurality of axes. The system also includes an end effector that is coupled to a distal end of the industrial robot. The end effector can include a saw cutting tool and a water jet cutting tool. Further, the system can include an off-line tool path creator. The off-line tool path creator can include an initial tool path creator and a kinematic singularity detector. The off-line tool path creator can also include a first corrected sub-path creator, wherein the first corrected sub-path includes variations to the initial tool path that avoid kinematic singularities. The off-line tool path creator also includes a collision detector and a second corrected sub-path creator. The second the second corrected sub-path includes variations to the first tool path that avoid collisions. The off-line tool path creator also includes a tool path translator, wherein the tool path translator translates the second corrected sub-path into industrial robot readable instructions.

In one embodiment, the first and second corrected sub-paths include rotating the end effector about the axis of rotation of a saw blade of the saw cutting tool.

In another embodiment, the first and second corrected sub-paths include incrementally moving the end effector in the z-axis.

In one embodiment, the first and second corrected sub-paths include rotating the end effector about the axis of rotation of the saw blade and incrementally moving the end effector in the z-axis.

In yet another embodiment the initial tool path is parsed into individual motion segments.

In an embodiment the individual motion segments of the initial tool path are corrected for kinematic singularities and combined into a first corrected sub-path.

In one embodiment, the industrial robot contains 6 axes of rotation. In another embodiment, the industrial robot includes more than 6 axes of rotation, and in another embodiment, the industrial robot includes less than 6 axes of rotation.

In one embodiment, the first corrected sub-path is reanalyzed for singularity occurrence.

In another embodiment, the first and second corrected sub-paths include manipulating a sixth, fifth, and fourth axes of the industrial robot such that the end effector takes the same path, but with the sixth, fifth, and fourth axes in different positions.

In one embodiment, a center point of the saw blade lies on a sixth axis of rotation of the industrial robot but the axis of rotation of the saw blade is orthogonal to the sixth axis of rotation.

In an alternative embodiment, the center point of the saw blade does not lie on the sixth axis of rotation of the industrial robot.

In an alternative embodiment, a method for cutting a slab of material is disclosed. The method comprises creating an initial tool path for an end effector of an industrial robot based on a prescribed cut pattern, wherein the end effector includes a water jet cutting head and a saw having a saw blade with an axis of rotation. The method further includes analyzing the initial tool path for kinematic singularity occurrences and creating a first corrected sub-path, and then analyzing the first corrected sub-path for kinematic singularity occurrences. The method further includes analyzing the first corrected sub-path for collisions and creating a second corrected sub-path and then analyzing the second corrected sub-path for collisions. The method includes translating and sending the second corrected sub-path to an industrial robot. The method then include running the end effector along the second corrected sub-path, loading a slab of material onto a table of the industrial robot and running the end effector along the second corrected sub-path to cut the slab of material.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1A is a side view of an industrial robot with a saw and water jet end effector, according to embodiments.

FIG. 1B is an isometric view of a saw and water jet end effector, according to embodiments.

FIG. 1C is a side view of a saw blade and bracket of a saw and water jet end effector, according to embodiments.

FIG. 1D is a side view of a saw blade and bracket of a saw and water jet end effector, according to embodiments.

FIG. 2 is a flowchart for a kinematic singularity and collision avoidance system, according to embodiments.

FIG. 3 is an expanded flowchart depicting the initial tool path creation, according to embodiments.

FIG. 4 is an expanded flowchart depicting off-line programming for a saw and water jet end effector, according to embodiments.

FIG. 5 is expanded flowchart depicting on-line programming for a saw and water jet end effector, according to embodiments.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments disclosed herein are directed to devices, systems and methods of avoiding kinematic singularities and collisions in industrial robots with a saw and water jet end effector. In embodiments, a 6 axis industrial robot is discussed, yet, industrial robots having more or less axes can be used the disclosed embodiments. In embodiments, the industrial robots discussed herein can be operated using a robotic controller. The robotic controller can comprise a programmable central processing unit, a memory, a user interface, and various inputs for communication with other programmable central processing units. In embodiments, the user interface can include a teaching pendant, for example.

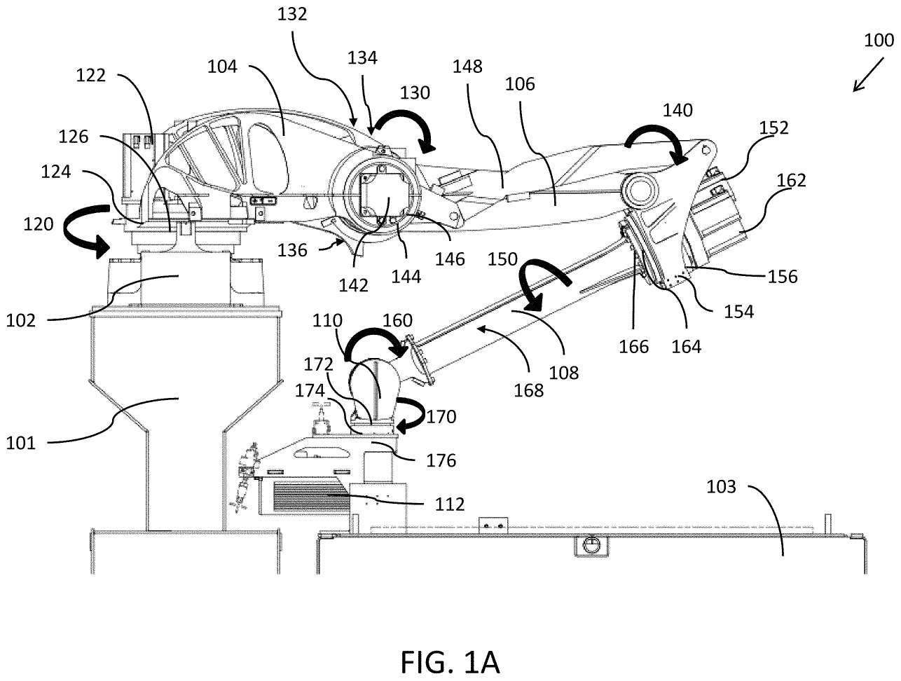

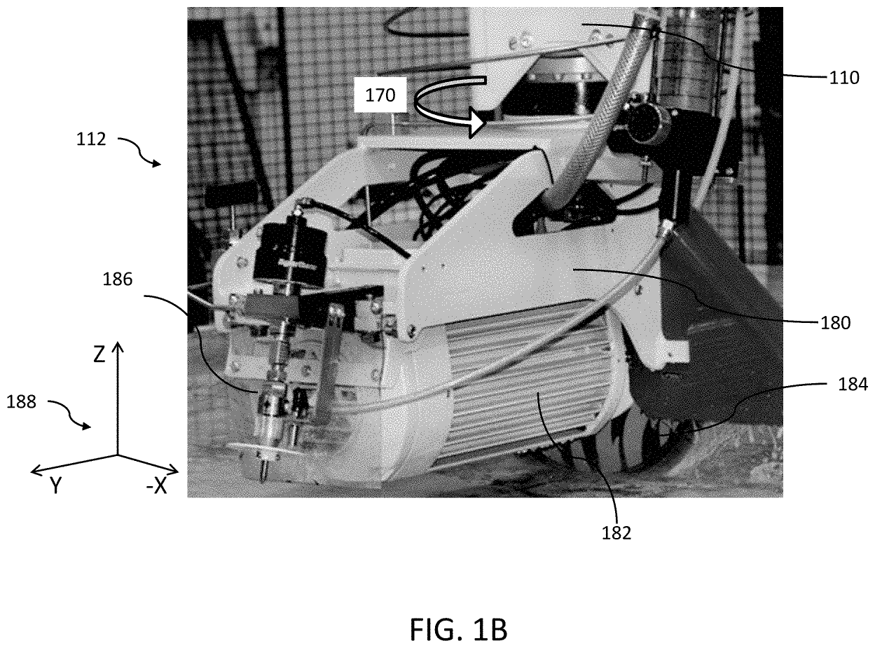

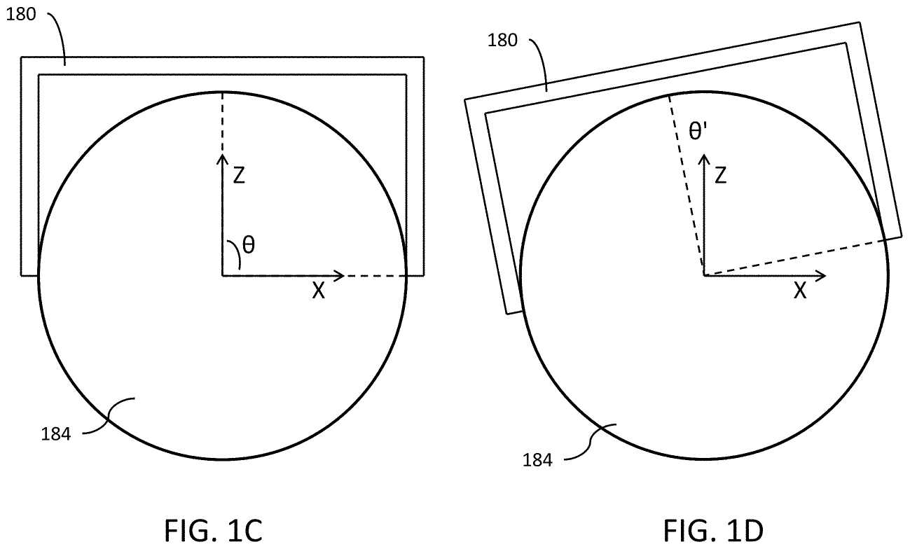

FIG. 1A depicts an embodiment of a 6 axis industrial robot 100 having 6 degrees of freedom. Further, industrial robot 100 is operated using a robotic controller. In this embodiment, industrial robot 100 can include a pedestal 101, a base 102, a table 103, a first arm 104, a second arm 106, a third arm 108, a fourth arm 110, and an end effector 112.

In embodiments, pedestal 101 couples to the ground and supports base 102. Pedestal 101 is sized and shaped to support base 102 at a height such that end effector 112 can operate directly below first arm 104 and second arm 106. Base 102 can be rotatably coupled to first arm 104 at first axis 120. First axis 120 includes a servomotor 122, reduction gear 124, and position sensor 126. In embodiments, servomotor 122 and reduction gear 124 are configured to rotate first arm 104 with respect to base 102. Further, position sensor 126 is configured to relay axis position information, with high accuracy in some embodiments, to the robotic controller. The robotic controller uses the axis position information sent from position sensor 126 to control motion and speed of motion of first arm 104 at first axis 120.

In embodiments, first arm 104 can be rotatably coupled to second arm 106 at second axis 130. Second axis 130 includes a servomotor 132, reduction gear 134, and position sensor 136. In embodiments, servomotor 132 and reduction gear 134 are configured to rotate second arm 106 with respect to first arm 104. Further, position sensor 136 is configured to relay position information, with high accuracy in some embodiments, to the robotic controller. The robotic controller uses the position information sent from position sensor 136 to control motion and speed of motion of second arm 106 at second axis 130.

In embodiments, second arm 106 can be rotatably coupled to third arm 108 at third axis 140. In this embodiment, third axis 140 is powered by a servomotor 142, reduction gear 144, position sensor 146, and hinged arm 148 arranged adjacent to second axis 130. In embodiments, servomotor 142 and reduction gear 144 are configured to rotate third arm 108 with respect to second arm 106 via hinged arm 148. Further, position sensor 146 is configured to relay position information, with high accuracy in some embodiments, to the robotic controller. The robotic controller uses the position information sent from position sensor 146 to control motion and speed of motion of third arm 108 at third axis 140.

In embodiments, third arm 108 can rotate about its own axis and thus forms fourth axis 150. Fourth axis 150 includes a servomotor 152, reduction gear 154, and position sensor 156. In embodiments, servomotor 152 and reduction gear 154 are configured to rotate third arm 108 about itself. Further, position sensor 156 is configured to relay position information, with high accuracy in some embodiments, to the robotic controller. The robotic controller uses the position information sent from position sensor 156 to control rotation and speed of rotation of third arm 108.

In embodiments, fourth arm 110 can be rotatably coupled to third arm 108 at fifth axis 160. In this embodiment, fifth axis 160 is powered by a servomotor 162, reduction gear 164, position sensor 166, and shaft 168 arranged adjacent to third axis 140. In embodiments, servomotor 162 and reduction gear 164 are configured to rotate fourth arm 110 with respect to third arm 108 via shaft 168. Further, position sensor 166 is configured to relay position information, with high accuracy in some embodiments, to the robotic controller. The robotic controller uses the position information sent from position sensor 166 to control motion and speed of motion of fourth arm 110. Because pedestal 101 has a height such that end effector 112 can operate below first arm 104 and second arm 106, fifth axis 160, third axis 140, and second axis 130 can operate orthogonally to the same plane as is depicted in FIG. 1A.

In embodiments, end effector 112 can rotate about fourth arm 110 at sixth axis 170. sixth axis 170 includes a servomotor 172, reduction gear 174, and position sensor 176. In embodiments, servomotor 172 and reduction gear 174 are configured to end effector 112 about fourth arm 110. Further, position sensor 176 is configured to relay position information, with high accuracy in some embodiments, to the robotic controller. The robotic controller uses the position information sent from position sensor 176 to control rotation and speed of rotation of end effector 112 about fourth arm 110.

Referring now to FIG. 1B which is an isometric view of end effector 112. In embodiments industrial robot 100 is configured for cutting slabs of material, such as granite or marble. For this use, end effector 112 of industrial robot 100 includes a bracket 180, saw motor 182, rock-cutting saw blade 184, and water jet cutting head 186. In embodiments, bracket 180 of end effector 112 is configured to couple to fourth arm 110 at sixth axis 170. Bracket 180 is also configured to support saw motor 182 at a first end and water jet cutting head 186 at a second end, which is opposite the first end. Further, rock-cutting saw blade 184 couples to an output shaft of saw motor 182.

In some embodiments, the centroid of saw blade 184, i.e., the radial center of saw blade 184 and the center of the thickness of saw blade 184, fall on the axis of rotation of sixth axis 170. Yet, in other embodiments, saw blade 184 is offset from sixth axis 170. In this embodiment, water jet cutting head 186 is arranged opposite saw blade 184. In embodiments, water jet cutting head 186 is configured to deliver a mixture of water and an abrasive, such as garnet, at high enough pressures such that the abrasive mixture forms a cut in the work piece. In embodiments, saw blade 184 is used to cut straight sections of the work piece at a high rate of speed and water jet cutting head 186 is used to cut curves and corners, but at a slower rate of speed.

In embodiments, a coordinate system 188 can be used to describe the position of end effector 112 with respect to table 103. In coordinate system 188, the XY plane is coplanar with table 103 and the Z axis is normal to table 103. In some embodiments, Z=0 can be set at various positions, such as the work piece surface or the surface of table 103.

In embodiments, end effector 112 can be positioned in a wide variety of positions within coordinate system 188 by manipulating the various angular positions of the six axes of industrial robot 100. As previously noted, there are positions within the end effector work envelope that are considered kinematic singularities. Kinematic singularities are motion stop events that occur when industrial robot 100 is positioned such that two or more of its axes align with each other and consequently render associated joint positions indeterminant.

Referring now to FIGS. 1C and 1D, which are side views of saw blade 184 and bracket 180 of end effector 112. Kinematic singularities can be avoided by altering the orientation of industrial robot 100 while maintaining the effectiveness of saw blade 184 with respect to making a cut in the work piece. Altering the orientation of end effector 112 imposes different positional requirements for one or more of the six axes of industrial robot 100 through the cut path. The result then, is that the kinematic singularity is avoided. For example, and referring to FIG. 1C, the Z position of end effector 112 can be altered slightly, so as to make a similar cut in the work piece while having slightly different rotational positions for one or more of the six axes of industrial robot 100. If the depth of cut (i.e., the Z-position) must remain the same, and referring now to FIG. 1D, the same cut can be made with saw blade 184 and bracket 180 at an angular tilt of θ′. In this approach, end effector 112 is treated as a pendulum component and tilted, at an angular tilt θ′, so as to create the same cut while having one or more of the six axes of industrial robot 100 at different rotational positions.

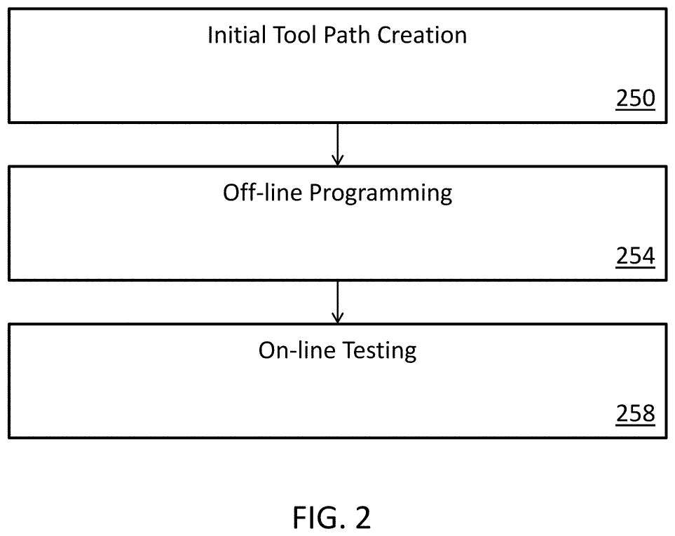

Referring now to FIG. 2 which is a flowchart for a kinematic singularity and collision avoidance system, a cut pattern is imported from a computer aided drafting program (“CAD”) for initial tool path creation at initial tool path creator module 250. The tool path is sent for off-line programming using an off-line programming module 254 to detect and avoid kinematic singularities and collisions. The verified tool path is then sent to the robot for final on-line testing using an on-line tester 258 which includes a teaching pendant.

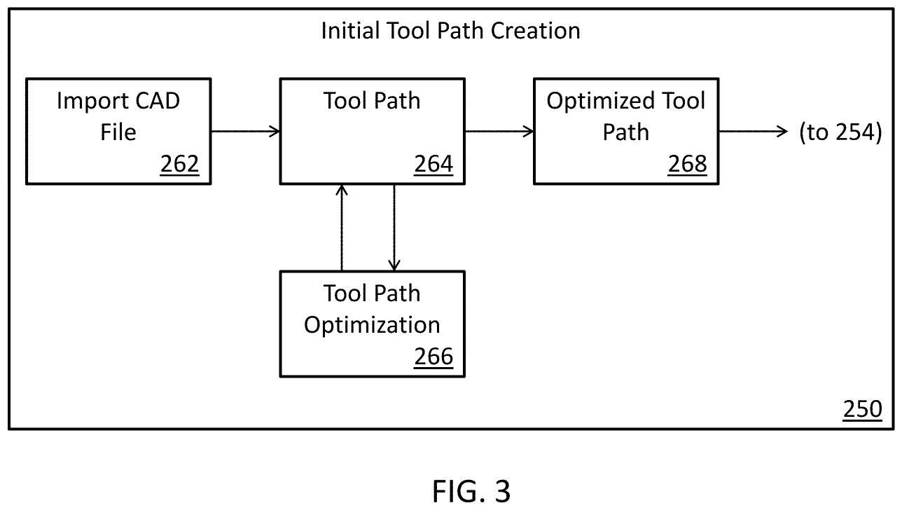

FIG. 3 is an expanded flowchart of initial tool path creator module 250. A CAD file, a DXF file, for example, is imported using an importing module 262 and a tool path 264 is created based on the CAD file. Tool path 264 is run through tool path optimization using a tool path optimizing module 266 to create an initial tool path 268. Once initial tool path 268 is created, it is sent to off-line programming module 254.

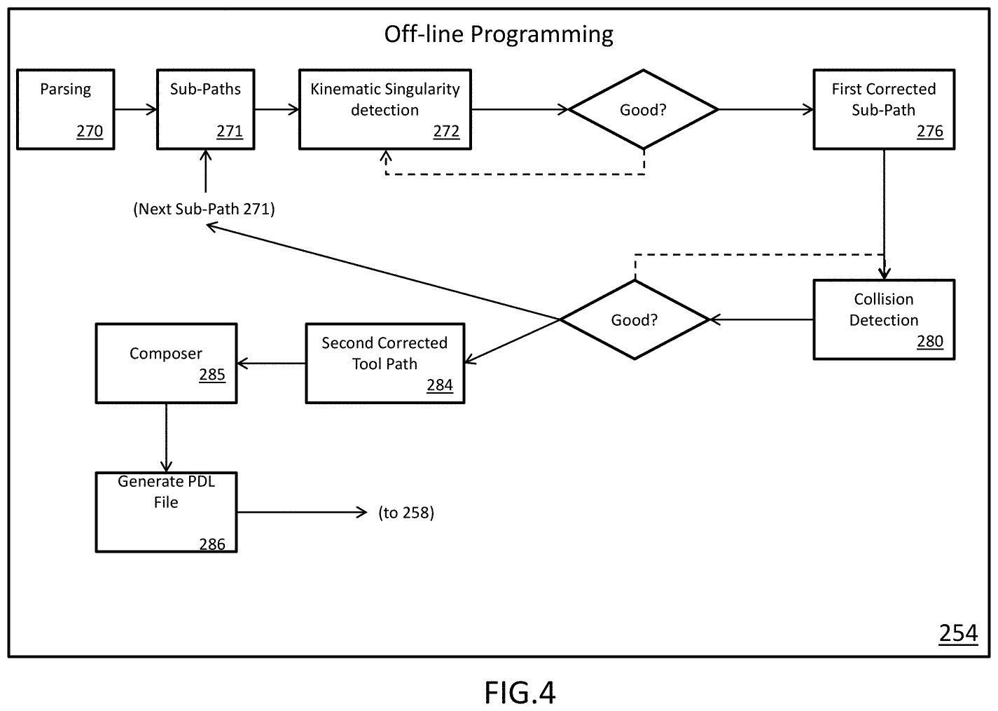

FIG. 4 is an expanded flowchart depicting off-line programming module 254 for industrial robot 100. In particular, off-line programming module 254 checks for and resolves kinematic singularities, then checks for and resolves collisions. In embodiments, off-line programming module 254 and simulation avoids singularities by detecting them, then changing the instructions for the robot such that end effector 112 reaches the same point coordinate in a difference way, i.e., a way that does not configure the robot in a kinematic singularity orientation.

Initial tool path 268 is run through parsing module 270 which isolates individual cut paths and in-between-cut travel movements such that as series of sub-paths 271 are created. Parsing module 270 is required before further analysis as sub-paths 271 that are cutting operations have different requirements and solutions than sub-paths 271 that are in-between-cut travel movements with respect to speed and end effector 112 orientation. Further, separating the initial tool path 268 into sub-paths 271 allows solutions to singularities and collisions to be more quickly remedied. Faster resolution is possible in that if a singularity or collision is detected in a particular sub-path 271, at most only the subject sub-path 271, the previous sub-path 271, and the subsequent sub-path 271 need to be modified. If initial tool path 268 is analyzed as a whole and a singularity or collision is detected, the entire initial tool path 268 must be reanalyzed and modified.

Each sub-path 271 of initial tool path 268 is run through kinematic singularity detection using kinematic singularity detection module 272 where the segments are checked for kinematic singularities. An example of a kinematic singularity would be a tool path where saw blade 184 cuts across the work piece and encounters a position within the tool path where fourth axis 150 and sixth axis 170 are aligned and joint position indication is therefore lost.

After kinematic singularity detection module 272 detects no singularities and sub-path 271 is good, a first corrected sub-path 276 is created. In one embodiment, first corrected sub-path 276 can include implementing an angular tilt to end effector 112. The angular tilt can be made about the axis of rotation of saw blade 184, as is depicted in FIG. 1D. In this embodiment of first corrected sub-path 276, end effector 112 is treated as a pendulum component and tilted, at an angular tilt θ′, so as to create the same cut while having one or more of the six axes of industrial robot 100 at different rotational positions.

In an alternative embodiment, first corrected sub-path 276 can include implementing a change in the Z position of end effector 112. In this embodiment, first corrected sub-path 276 implements an altered Z position of end effector 112, so as to make a similar cut in the work piece while having slightly different rotational positions for one or more of the six axes of industrial robot 100. In this embodiment, the change in Z position is limited such that any change made ensures a full cut in the work piece.

In an alternative embodiment, first corrected sub-path 276 can include implementing both an angular tilt and a change in the Z position of end effector 112. The angular tilt can be made about the axis of rotation of saw blade 184, as is depicted in FIG. 1D. In this embodiment of first corrected sub-path 276, end effector 112 is treated as a pendulum component and tilted, at an angular tilt θ′, so as to create the same cut while having one or more of the six axes of industrial robot 100 at different rotational positions. At the same time, first corrected sub-path 276 implements an altered Z position of end effector 112, so as to make a similar cut in the work piece while having yet more change in rotational positions for one or more of the six axes of industrial robot 100. In this embodiment, the change in Z position is limited such that any change made ensures a full cut in the work piece.

Further, if a kinematic singularity is detected within a sub-path 271 requiring water jet cutting head 186, first corrected sub-path 276 can include implementing a change in the Z position of end effector 112. Because water jet cutting head 186 must remain orthogonal to the x-y plane during cutting, the Z position correction is a viable option for correcting kinematic singularities that occur within sub-paths 271 that utilize water jet cutting head 186. In this embodiment, first corrected sub-path 276 implements an altered Z position of end effector 112, so as to make a similar cut in the work piece while having slightly different rotational positions for one or more of the six axes of industrial robot 100. In this embodiment, the change in Z position is limited such that any change made ensures a full cut in the work piece. In other words, the change in the Z position must ensure that water jet cutting head 186 is still effectively cutting the work piece.

First corrected sub-path 276 is then analyzed by a collision detection module 280. In particular, collision detection module 280 checks for collisions that occur in first corrected sub-paths 276 that are movements between cutting operations, i.e. when end effector 112 is instructed to move between two points as quickly and efficiently as possible. An example of a collision would be when first corrected sub-path 276 instructs end effector 112 starts at the end one cut, and ends at the start of another cut at a different point on the work piece but the path of travel taken between these two points intersects the work piece. Collisions can cause damage to the work piece, end effector 112, and even industrial robot 100 itself.

Once collision detection module 280 clears first corrected sub-path 276 of all collisions and is considered good, a second corrected sub-path 284 is created. In embodiments, second corrected sub-path 284 can include variations in travel paths such as a different line of travel, different end effector 112 orientation, or any other suitable variation that avoids the detected collision. In particular, second corrected sub-path 284 can include manipulating sixth axis 170, fifth axis 160, and fourth axis 150, such that end effector 112 is in the same position and takes the same path but with sixth axis 170, fifth axis 160, and fourth axis 150 in different positions.

Once second corrected sub-path 284 is created and stored, offline programming 254 begins to analyze the next sub-path 271. When all sub-paths 271 have been remedied of all singularities and collisions and stored as second corrected sub-paths 284, a composer module 285 reintegrates second corrected sub-paths 284 into final tool path instructions. Composer module 285 can be viewed as the opposite of parsing module 270 in that individual sub-paths are linked back together so as to create path instructions for end effector 112 to create a full finished part.

In some embodiments, second corrected sub-path 284 is analyzed by kinematic singularity detection module 272 and collision detection module 280 a final time to ensure that no corrections made in first corrected sub-path 276 and second corrected sub-path 284 imposed new kinematic singularities or collisions. In other embodiments, the only collision corrections that can be implemented in second corrected sub-path 284 are only those that do not intersect a kinematic singularity and thus, the final analysis through kinematic singularity detection module 272 and collision detection module 280 review can be eliminated.

Once second corrected sub-paths 284 are combined via composer module 285, the final tool path instructions can be converted into a industrial robot instructional language file such as a perl data language (“PDL”) file by a PDL file generator module 286. In some embodiments, industrial robot instructional language could any other suitable language. PDL file generator module 286 is then sent to the robotic controller of industrial robot 100.

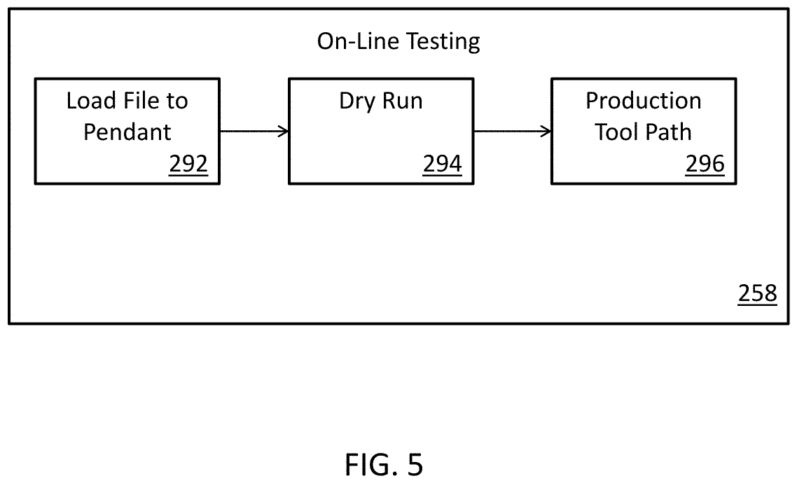

FIG. 5 is expanded flowchart of on-line tester 258. On-line tester 258 includes downloading accessing the PDL file created by PDL file generator module 286 through the teaching pendant of industrial robot 100. Using the teaching pendant, a dry run of second corrected sub-path 284 is performed by a dry run testing module 294. If the dry run reveals an error in second corrected sub-path 284, such as a kinematic singularity or collision, second corrected sub-path 284 will be sent to off-line programming module 254 again. If the dry run of second corrected sub-path 284 is error free, a production tool path 296 is created and can be used to cut a slab of material.

In operation, a user creates a CAD file of the finished work piece design. The CAD file is then imported into tool path creation module 250. Once initial tool path 268 is created, it is sent to off-line programming module 254 for kinematic singularity and collision avoidance. Off-line programming module 254 includes an iterative combination of kinematic singularity detection module 272 and consequent creation of first corrected sub-path 276 to address kinematic singularities. Off-line programming module 254 also includes an iterative combination of collision detection module 280 and consequent creation of second corrected sub-path 284 to address collisions. An industrial robot language file, i.e., PDL file 286, is created and sent to the robotic controller for on-line tester 258. The user then performs dry run using the dry run testing module 294 which includes the teaching pendant. If on-line tester 258 reveals no tool path errors, second corrected sub-path can be run on a work piece.

In embodiments, the devices disclosed herein and/or their components or systems include computing devices, microprocessors and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

1. A system for cutting a slab of material comprising:
an industrial robot having a plurality of axes;
an end effector coupled to a distal end of the industrial robot and including a saw cutting tool and a water jet cutting tool;
an off-line tool path creation module further comprising:
an initial tool path creation module, the initial tool path creation module configured to create an initial tool path,
a kinematic singularity detection module, the kinematic singularity detection module configured to detect kinematic singularities,
a first corrected sub-path creation module, wherein the first corrected sub-path creation module is configured to create a first corrected sub-path and further includes variations to the initial tool path that avoid kinematic singularities,
a collision detection module, the collision detection module configured to detect collisions,
a second corrected sub-path creation module wherein the second corrected sub-path creation module is configured to create a second corrected sib-path and further includes variations to the first corrected sub-path that avoid collisions; and
a robotic controller configured to instruct the industrial robot to cut a slab of material according to the second corrected sub-paths.

2. The system of claim 1, wherein the first and second corrected sub-paths include rotating the end effector about the axis of rotation of a saw blade of the saw cutting tool.

3. The system of claim 1, wherein the first and second corrected sub-paths include incrementally moving the end effector in the vertical axis.

4. The system of claim 1, wherein the first and second corrected sub-paths include rotating the end effector about the axis of rotation of the saw blade and incrementally moving the end effector in the vertical axis.

5. The system of claim 1, wherein the initial tool path is parsed into sub-paths.

6. The system of claim 5, wherein the sub-paths are corrected for kinematic singularities and collisions and combined into a final tool path.

7. The system of claim 1, wherein the industrial robot contains 6 axes of rotation.

8. The system of claim 1, wherein the first and second corrected sub-paths include manipulating a sixth, fifth, and fourth axes of the industrial robot such that the end effector takes the same path, but with the sixth, fifth, and fourth axes in different positions.

9. The system of claim 2, wherein a center point of the saw blade lies on a sixth axis of rotation of the industrial robot but the axis of rotation of the saw blade is orthogonal to the sixth axis of rotation.

10. The system of claim 2, wherein the center point of the saw blade does not lie on a sixth axis of rotation of the industrial robot.

11. A method for cutting a slab of material, the method comprising:
creating an initial tool path for an end effector of an industrial robot based on a prescribed cut pattern, wherein the end effector includes a water jet cutting head and a saw having a saw blade with an axis of rotation;
analyzing the initial tool path for kinematic singularity occurrences;
creating a first corrected sub-path;
analyzing the first corrected sub-path for collisions;
creating a second corrected sub-path; and
translating and sending the second corrected sub-paths to an industrial robot;
running the end effector along the second corrected sub-paths;
loading a slab of material onto a table of the industrial robot; and
running the end effector along the second corrected sub-paths to cut the slab of material.

12. The method of claim 11, wherein the first and second corrected sub-paths include rotating the end effector about the axis of rotation of the saw blade.

13. The method of claim 11, wherein the first and second corrected sub-paths include incrementally moving the end effector in the vertical axis.

14. The method of claim 11, wherein the first and second corrected sub-paths include rotating the end effector about the axis of rotation of the saw blade and incrementally moving the end effector in the vertical axis.

15. The method of claim 11, wherein the initial tool path is parsed into sub-paths.

16. The method of claim 15, wherein the individual motion segments are corrected and combined into a first corrected sub-path.

17. The method of claim 11, wherein the industrial robot contains 6 axes of rotation.

18. The method of claim 11, wherein the first and second corrected sub-paths include manipulating a sixth, fifth, and fourth axes of the industrial robot such that the end effector takes the same path, but with the sixth, fifth, and fourth axes in different positions.

19. The method of claim 11, wherein the center point of the saw blade does not lie on the sixth axis of rotation of the industrial robot.

20. The method of claim 11, wherein the center point of the saw blade lies on the sixth axis of rotation of the industrial robot but the axis of rotation of the saw blade is orthogonal to the sixth axis of rotation.
